(19) United States
(12) Patent Application Publication
(10) Pub. No.: US 2009/0184922 A1
(43) Pub. Date: Jul. 23, 2009

(54) Display indicator controlled by changing an angular orientation of a remote wireless-display controller

(75) Inventor: Ruey-Der Lou, Hsinchu City (TW)

Correspondence Address: BO-IN LIN, 13445 MANDOLI DRIVE, LOS ALTOS HILLS, CA, 94022, US

(73) Assignee: IMU Solutions, Inc.

(21) Appl. No.: 12/321,539

(22) Filed: Jan. 21, 2009

Related U.S. Application Data
(60) Provisional application No. 61/011,665, filed on Jan. 18, 2008.

(51) Int. Cl. G09G 5/00

(52) U.S. Cl. 345/156

(57) ABSTRACT

A remote controller for controlling a presentation image is disclosed. The remote controller includes gyroscope to detect the movement and angular speed of the remote controller and generate corresponding signals for transmitting to a computer or projection system. The movement or angular speed signals are processed and applied to move a display cursor or highlight indicator in different areas of the display image according to the movements and angular speed and positions of the remote controller thus enhancing the control the image of the presentation without requiring the presenter to look away from the screen in search of many different push buttons to control the presentation images.

This Non-provisional Application claims a Priority Date of Jan. 18, 2008 benefited from a Provisional Patent Applications 61/011,665 filed by an Applicant as one of the Inventors of this Application. The disclosures made in patent application No. 61/011,665 are hereby incorporated by reference in this Application.

### BACKGROUND OF THE INVENTION

1. Field of the Invention

This invention relates generally to a device and method for remotely control a display indicating-image with a wireless controller. More particularly, this invention relates to new devices and methods for implementing a wireless remote display controller that enables a user to control the electronic device by changing an angular orientation of the display indicator controller.

2. Description of the Prior Art

Conventional techniques for providing wireless remote controller to control display images are still confronted with technical difficulties and limitations. Specifically, it is quite common to control a computer for controlling the image projected from a projector connected to the computer for making a presentation in a meeting. A mouse may be employed to control the display for a small meeting even though the cursor is usually too small and inconvenient for the participant to clear see the location of the cursor, particularly to those who sit far away from the screen. For a meeting with larger size of attendants, a laser pen is usually used with higher light intensity. However, the speaker has to continuously point to the screen to draw the attention of the audience to the particular point of the display. Once, the speaker holding the laser pen to point away from the screen due to a hand movement away from the projected images, the particular location of the presentation is no longer shown and visual contacts with the presentation images are lost. Furthermore, a speaker using a laser pen in a presentation must often require an assistance from another person to control the computer or otherwise the speaker must come back to the computer to control the projected images. All these inconveniences and disruptions hinder the effectiveness of the presentations.

Therefore, a need still exists in the art of image projection control and remote controller configuration and operation to provide new and improved methods and processes to overcome the above-discussed difficulties and limitations.

### SUMMARY OF THE PRESENT INVENTION

One aspect of this invention is to provide wireless remote controller that enables a speaker to remotely control a computer and an image display device by moving and tilting a wireless remote controller. The movements and tilting action of the remote controller generate control signals to the computer and the image projector to move the display cursor and to control the image projection operations with simplified and intuitive actions with reduced requirement of pressing down a control button on the remote controller.

A computer or the projector is provided with detector to detecting the movement and tilting angular positions of the remote controller. The computer or the projector is further provided with computational programs to compute the movement or rotational angles of the remote controller to activate corresponding cursor movements or change of display operations accordingly based on the results of the calculations. Since the speaker is not required to press down many control buttons in operating the remote controller, the operations of the display projections may be changed while the speaker is looking at the display image thus enhancing the effectiveness of the presentation.

Another aspect of the present invention is to divide the image display into multiple segments or areas. The speaker holding the remote controller is provided to move and select different segments or areas of presentation by moving or rotating the wireless remote controller. The segments or areas may be highlighted or changing colors when selected by the speaker through the movement or rotation of the wireless remote controller. The visual effect and impress of the presentation can be significantly improved with the remote controller of this invention. The speaker may intuitive and conveniently control the display image while looking continuously on the displayed images without requiring to look away for searching and pressing the control buttons disposed on the wireless remote controller.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram of a wireless remote controller of this invention.

FIG. 2 is a diagram to illustrate the reference axes along three directions of a gyroscope implemented in the remote controller of this invention for controlling the display cursor or indicator on a projection screen.

FIG. 3 shows the vertical movement of the remote controller to move the display cursor or indicator along a corresponding up-down direction.

FIG. 4 shows the horizontal movement of the remote controller to move the display cursor or indicator along a corresponding left-right direction.

FIG. 5 is a diagram for showing the functional relationships between different axes under the condition when the remote controller is held along a horizontal direction with an angle θ≠0.

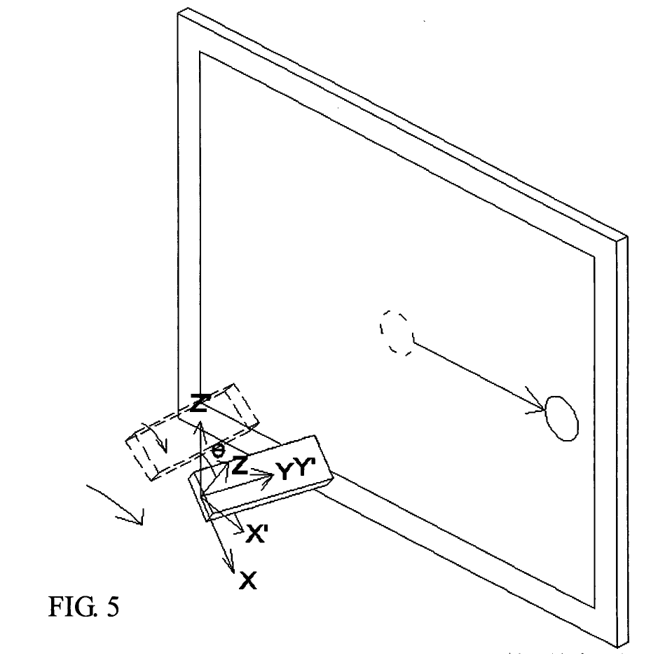

### DETAILED DESCRIPTION OF THE PREFERRED EMBODIMENT

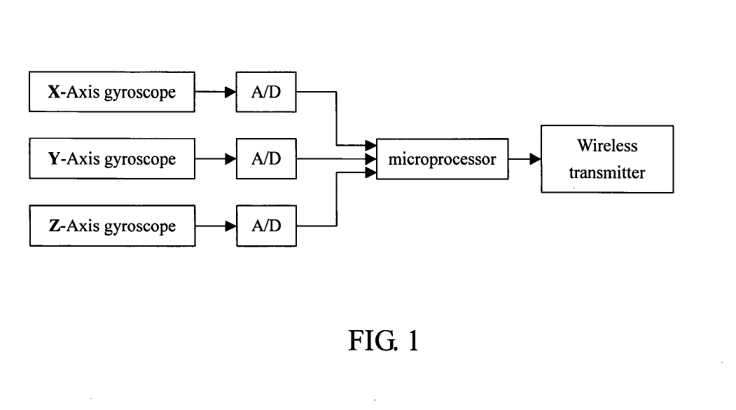

FIG. 1 is a functional block diagram for showing the structural configuration of a wireless remote controller of this invention. The remote controller includes a gyroscope operates with along three axes, i.e., X, Y and Z axes. The gyroscope generate signals for three axes that can be either digital or analog signals. FIG. 1 shows the signals generated by the X, Y and Z-gyroscopes as analog signals and processed and converted into digital signals by three corresponding analog-to-digital (A/D) Converters. The digital signals as detector by the three gyroscopes are inputted to a microprocessor and transmitted to a wireless transmitter to transmit to a receiver for providing the movement and angular position data of the remote controller. Specifically, the X-gyroscope detects an angular speed αₓ relative to the X-axis, the angular speed may be expressed as a function of the output value of the gyroscope Vₓ as:

αₓ=(Vₓ−V_{offsetx})/V_{sensitivityx}

Where the parameter V_{offsetx} represents the output value when the gyroscope is kept at a location without movement, while the parameter V_{sensitivityx} represents a unit conversion factor between (Vₓ−V_{offsetx}) expressed in the unit of volt and αₓ (expressed in a unit of rad/sec). The microprocessor receives these device parameters and the output voltages from three gyroscopes to compute the angular speeds along three axes. The wireless transmitter than transmit the angular speed to a computer implemented with a wireless receiver. The computer than applies the data of the angular speed to compute by integrating the angular speed data to obtain the movement and the change of locations and angular position of the remote controller.

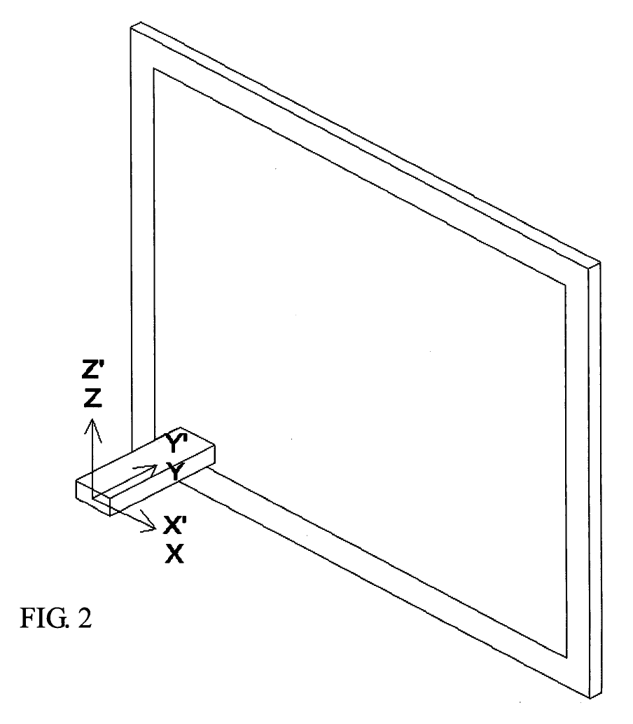

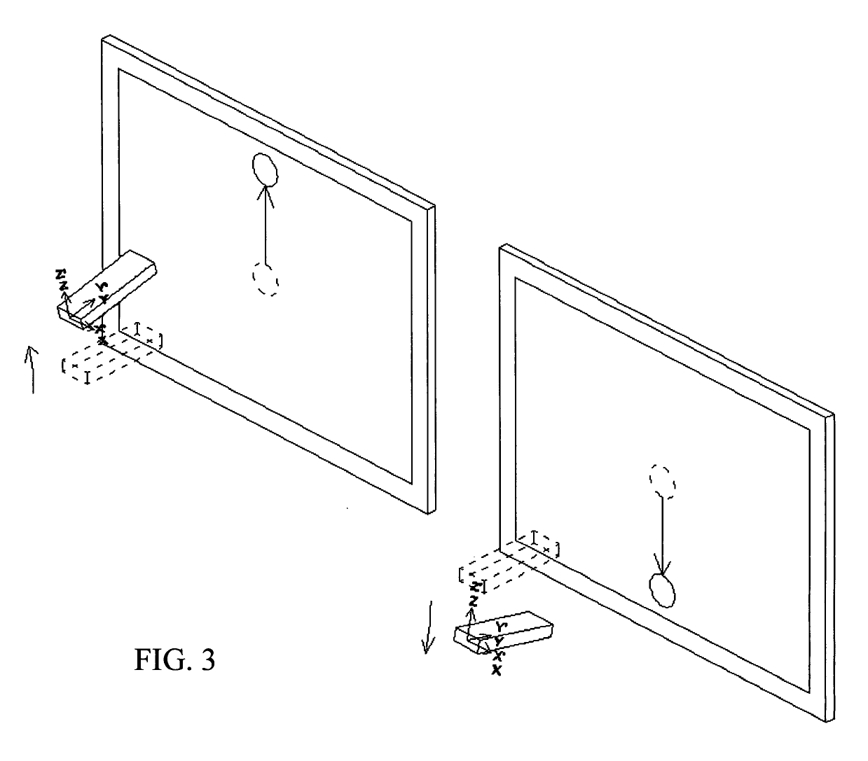

The remote controller as an image display indicator further includes a button. As the push button is pushed down, the computer will continue the operation of integrating the angular speed over a time period when the button is pushed down and stop the integration when the button is released while maintaining the latest value of integration for future application. A rest option is also provided for user to push the button at a higher speed to remove and delete all the previous position and angular orientation data to set the display cursor or indicator back to a reset default position. The resent function serves another important function of restoring the reference axes to the default reference directions as shown in FIG. 2. Based on the exemplary embodiment shown in FIG. 2, the Y-direction is along a longitudinal direction of the remote controller while the Z-axis is along an perpendicular direction relative to the Y-axis and X is pointing along a right horizontal direction relative to the Y axis. As the remote controller moves, these three axes are moved together with the remote controller. A reset operation will place the three reference axes to three new axes shown as X′, Y′ and Z′ according to what is shown in FIG. 3 that moves along with the remote controller.

As a speaker begins the presentation, the remote controller is pointed to the center of the screen as that shown in FIG. 2 and begins with a reset operation. An indicating image is shown in the center portion of the screen for indicating the remote controller now controls the image cursor or indicator at a central location. The X′, Y′ and Z′ axes are aligned with the X, Y and Z directions. As shown in Fig., when the remote controller is rotate to an angle θ y relative to the Y-axis, the X′ and Z′ directions are still maintained the same as the X and Z directions.

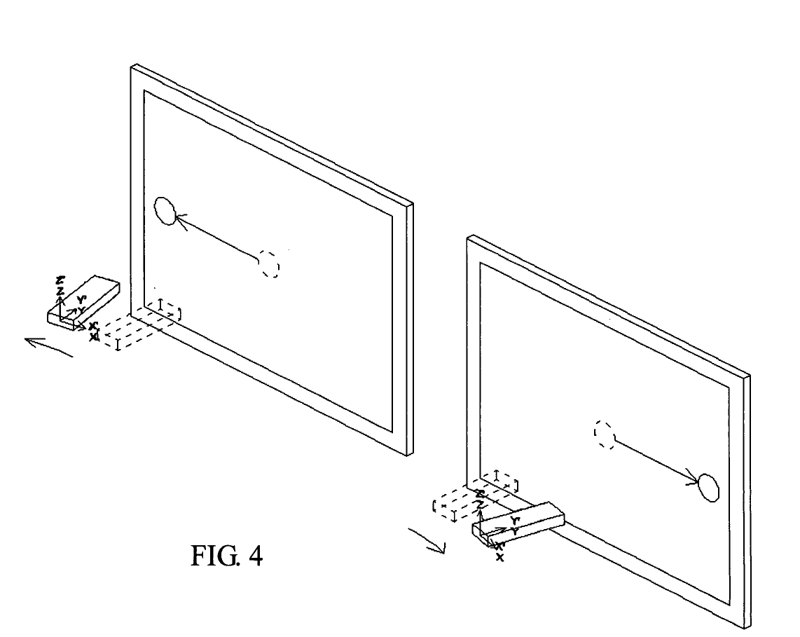

Under the condition when the angle θ y=0, and the user holding the remote controller to rotate the controller upward or downward relative to the X-axis, an angular speed is sensed by the X-axis gyroscope. The computer receives the angular speed data to computer the movement of the remote controller along a vertical direction. Similarly, the remote controller may be moved relative to the Z-axis along horizontal direction and the cursor or indicator is controlled to mover along a horizontal direction as shown respectively in FIGS. 3 and 4. The display area may be subdivided into many sub-areas. Each sub-areas may be highlighted when the cursor or indicator is controlled to move to that selected area shown as circles in FIGS. 3 and 4.

The remote controller may also be implemented to operate different control functions. Depending on the angular movement of the remote controller, the computer or the projector may be programmed to generate different operational instructions to simulate the operation of the computer mouse. For instance, the θ y may be used to change the size of the highlighted areas. A large angle generate a correspondingly larger size of the highlighted area for indicating and highlighting the segments or areas of presentation. When a remote controller is moved at a certain high speed, the operation may be programmed to simulated a return action of the mouse. Different functions may be implemented by detecting the movement and angular speed of the remote controller.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A method for controlling an image display device comprising:
moving a wireless remote controller without pressing down a control button on the wireless remote controller.
